(19) United States
(12) Patent Application Publication
(10) Pub. No.: US 2005/0269113 A1
(43) Pub. Date: Dec. 8, 2005

(54) Furrow cleaner apparatus

(76) Inventor: Erne Plessala JR., New Iberia, LA (US)

Correspondence Address: KEATY PROFESSIONAL LAW CORPORATION;THOMAS S. KEATY, 2533 AMERICAN WAY, PORT ALLEN, LA, 70767, US

(21) Appl. No.: 10/860,444

(22) Filed: Jun. 3, 2004

(51) Int. Cl. A01C 5/00; A01C 7/18; A01B 21/02

(52) U.S. Cl. 172/540

(57) ABSTRACT

A furrow cleaner has a rotating wheel with elongate blades that contact the obstructing matter in the eye of the furrow and move the obstruction to the side of an adjacent row. The blades are secured on radial arms attached to parallel disks, which in turn are secured on the central shaft of the wheel. The wheel is towed by a farming implement causing the blades to enter the furrow and move across the bottom of the furrow. The distance between the blades and their extension from the central shaft is adjusted by extending the length of the telescoping arms.

### BACKGROUND OF THE INVENTION

This invention relates to a soil-working machine, and more particularly to an apparatus for removing obstructing material from furrows.

The furrows are irrigation channels with planting beds aligned between the ditches. The furrows have sloping sides, narrow bottoms and increasing tops. The seeds are planted on top of the rows, while the bottom of the furrow serves as a channel for allowing water to flow between transverse channels, or ditches and the furrow. Since the field oftentimes presents an uneven terrain, depressions in the soil may form along the furrows. These depressions tend to accumulate water, while soil elevations prevent water from properly draining into the ditch or from being properly delivered from the ditch to irrigate the plants.

Sometimes, leaves and plant parts accumulate in the main ditches and special machines are employed to clear them. Such machines move through the field, throwing debris, dirt or sand from the cleaned path to the sides of the rows and into the furrows. As a result, the areas immediately adjacent to the main ditch become blocked by the mounds of soil, preventing water from freely flowing from and into the furrows. The water tends to accumulate in the eye of a furrow, making the soil soggy and potentially damaging nearby plants. Ideally, the furrows should maintain a constant depth in relationship to the irrigation channels and to the rows, thus allowing efficient use of water.

Conventionally, after a ditch digger passed through the field, the furrows need to be cleaned. It is often done by hand, a job that is time consuming and labor intensive. Some of the older technical solutions to this problem include furrow-cleaning apparatuses that have spoked or toothed trash-clearing fingers that dig into the furrows to help remove the trash from the critical areas adjacent the irrigation ditch. While some of these machines may work satisfactorily under favorable conditions, many of such older devices have difficulty going through wet mud and clearing soggy soil from the furrow entrance.

The present invention contemplates elimination of drawbacks associated with the prior art and provision of a furrow “eye” cleaner, which can operate in dry as well as wet soil conditions.

### SUMMARY OF THE INVENTION

It is, therefore, an object of the present invention to provide a furrow eye opening apparatus that can be employed for removing soil closing the entrance to the furrow from an irrigation ditch.

It is another object of the present invention to provide a furrow cleaning apparatus that can operate in dry as well as soggy soil conditions.

It is a further object of the present invention to provide a furrow cleaner that can be attached to a conventional farm implement, such as a tractor and be towed across the field during operation.

These and other objects of the present invention are achieved through a provision of a furrow cleaner apparatus adapted for attachment to a towing implement, for instance a tractor. The furrow cleaner has a wheel, which rotates about a central shaft in a direction transverse to the direction of travel of the implement. The wheel has a plurality of elongate blades, which contact the soil and move obstructing material to a side of a field row. The blades move in dimensional symmetry with respect to the plane of rotation of the wheel so as to retain a constant alignment of the blades with a furrow. The depth of contact of the blades with the ground remains constant.

The central shaft or wheel axle has a plurality of disks secured thereto. A plurality of arms or spokes extends from the disks in radial directions in relationship to the central shaft. The blades are attached to free ends of the radial arms and extend across several sets of parallel arms. The arms have adjustable longitudinal dimensions through a provision of telescoping portions, which allow extension of the blades to a pre-determined selected distance from the central shaft. This feature allows adjustment of the wheel for use in differently spaced rows and furrows.

The wheel is secured to the tractor by a hitch and a yoke, which engages opposite ends of the central shaft. The side arms, or rails of the yoke have greater length than the length of the radial arms so as not to interfere with the proper operation of the furrow cleaner.

### BRIEF DESCRIPTION OF THE DRAWINGS

Reference will now be made to the drawings, wherein like parts are designated by like numerals, and wherein FIG. 1 is a perspective view of the apparatus of the present invention positioned in a field.

FIG. 2 is a side view of the furrow cleaner in accordance with the present invention pulled by a tractor across the field.

FIG. 3 is a top view of the field with the apparatus of the present invention positioned between the furrows.

FIG. 4 is a side view of the furrow cleaning apparatus of the present invention showing blades and telescoping arms of the wheel of the apparatus of the present invention.

### DETAILED DESCRIPTION OF THE PREFERRED EMBODIMENT

Turning now to the drawings in more detail, numeral 10 designates the furrow opener of the present invention. The furrow opener 10 comprises a wheel 12 and an attachment assembly 14 adapted for securing the apparatus 10 to a towing implement, for instance a tractor 16. The wheel 12 comprises an elongated central shaft 20 and a plurality of disks 22 secured equidistantly along the length of the shaft 20. Secured to each disk 22 is a plurality of radially extending arms 24, which can be two or more in number.

Each radial arm 24 has an inner portion 26 and an outer portion 28. A part of the portion 26 telescopically extends within the outer portion 28, allowing to adjust the longitudinal dimension of the arm 24 to accommodate the wheel 12 for use in the fields with different distances between the furrow centers. The outer portion 28 of each arm 24 is securely attached to a respective disk 22 by detachable securing means, for instance bolts 30, 32 and respective nuts 34, 36.

A locking pin 38 passes through corresponding openings formed in the portions 26 and 28 to retain the inner and outer portions of the arms 24 at a desired pre-determined extension from the center of the disks 22. In the preferred embodiment, the arms 24 can be formed from hollow tubular members, for instance rectangular tubing and the disks 22 can be formed from flat non-corrosive plates of about 25 inches in diameter.

A retainer 40 is secured on an end 42 of the central shaft 20. A second retainer 44 is secured on the opposite end 46 of the shaft 20. The retainers 40 and 44 are designed to engage with a mounting yoke, which secures the wheel 12 to the tractor 16. The retainer 40 and 44 may be detachably secured on the ends 42 and 46 of the shaft 20.

The mounting yoke comprises elongated side arms 50 extending from the retainers 40 and 44 and connected by a cross member 52, which is secured on free ends of the side arms 50. The attachment assembly 14 is detachably engageable with the cross member 52, allowing to pull the wheel 12 along the field. The side arms 50 and the cross member 52 may be formed from a hollow tubular material, similar to the tubular material of the arms 24.

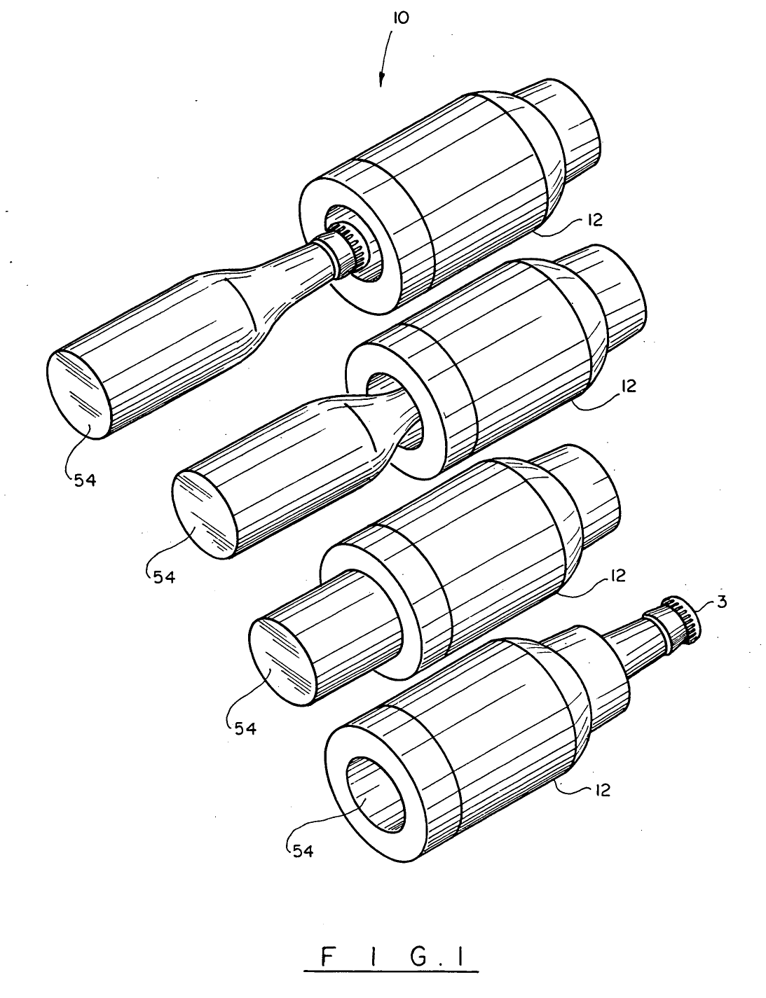

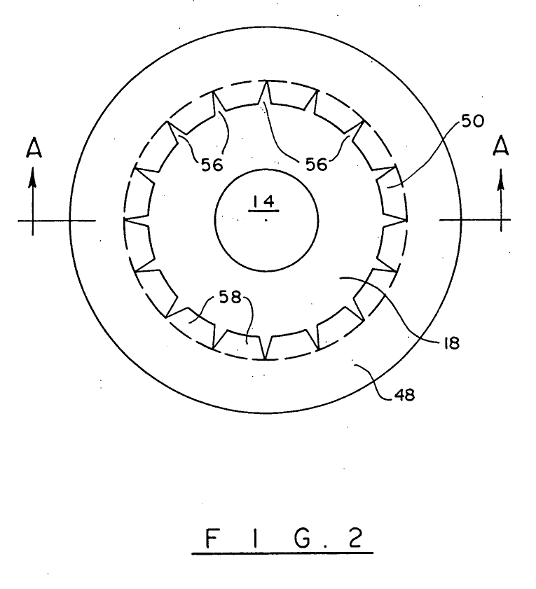

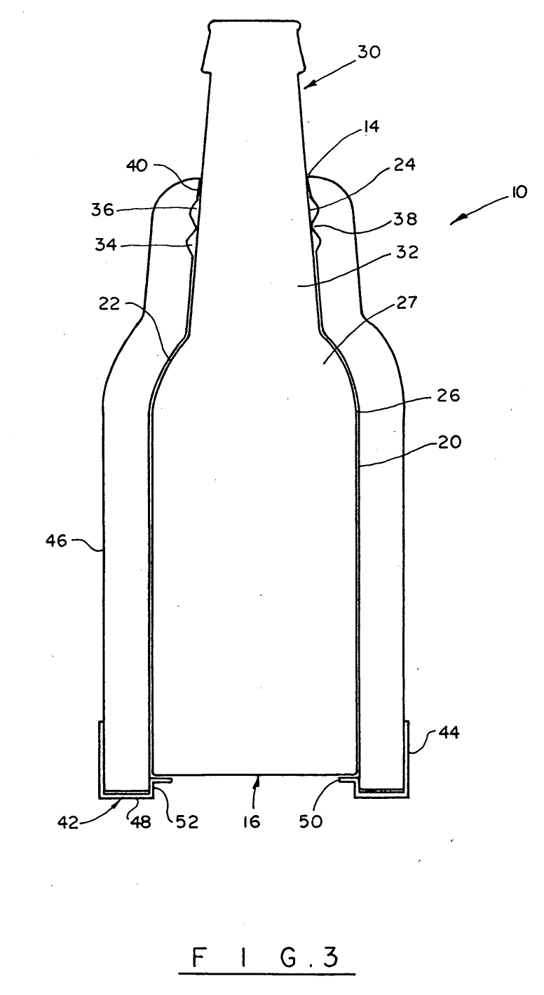

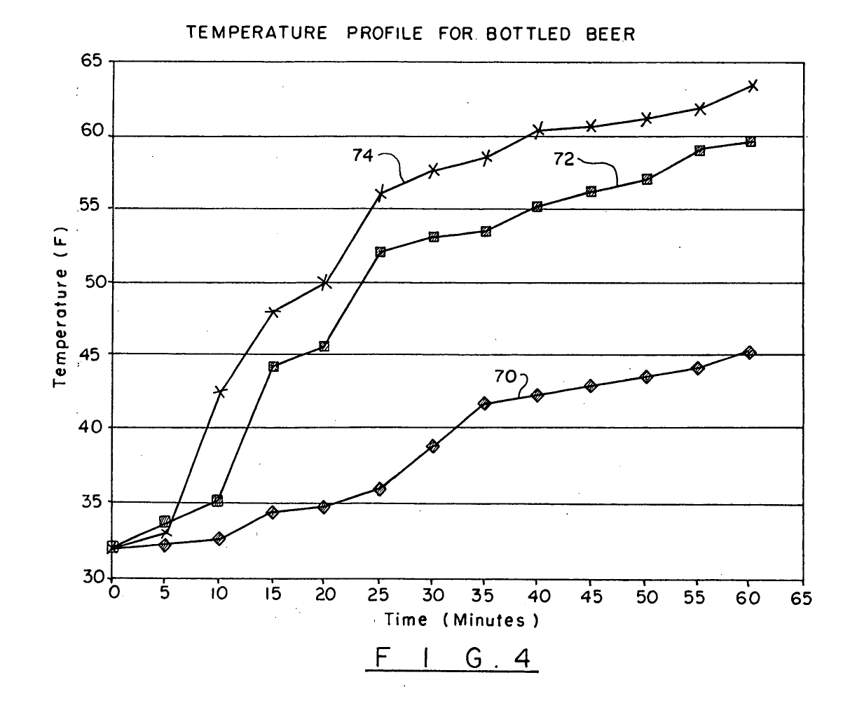

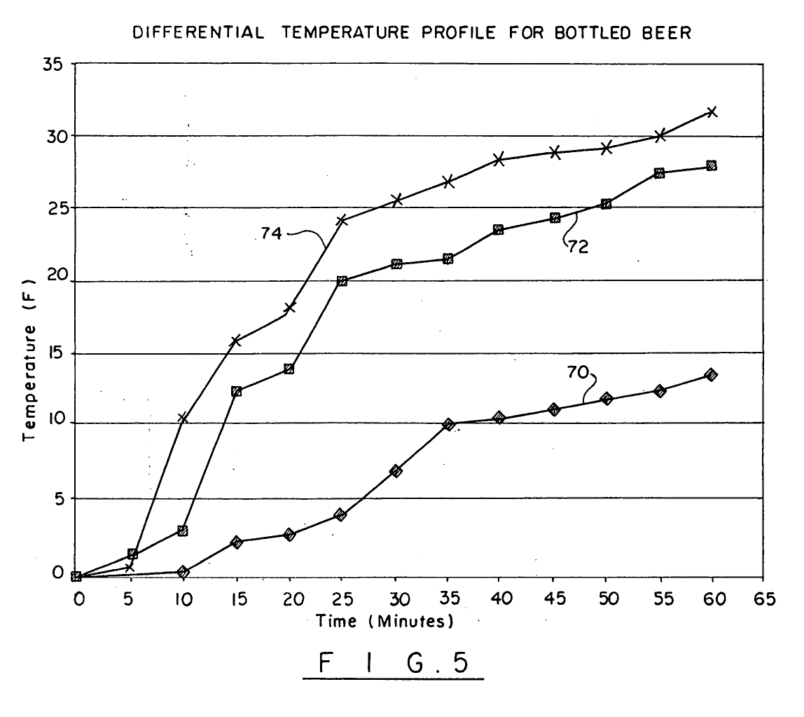

Extending in a parallel relationship to the central shaft 20 is a plurality of elongated blades 60, each of which is secured to free ends of the inner portions 26 of the arms 24. The blades 60 each have a V-shaped cross-section; an apex 62 of each blade 60 is oriented outwardly in relation to the central shaft 20. The cleaning apparatus illustrated in FIGS. 1-4 shows a wheel 12 having five blades 60. Of course, a different number of the blades may be used, depending on the particular design of the furrow cleaning apparatus.

The attachment assembly 14 comprises a pair of parallel rods 64 and 66 secured in a spaced-apart relationship to the cross member 52. A hitch connector 68 is mounted between the rods 64 and 66 allowing the farm implement, such as a tractor 16, to pull the wheel 12 along the field.

As can be seen in FIG. 1, the field is comprised of a plurality of rows 70 divided by furrows 72 extending transversely to an irrigation ditch 74. The irrigation ditch, or cross drain, 74, normally allows water to drain out of the furrows 72, into the ditch 74 when no obstruction is formed at the end of the furrow adjacent to the center ditch 74. Such unobstructed furrow is shown in FIG. 1 and is designated by numeral 76. However under certain circumstances, the ends of the furrows become clogged with dirt build up, as schematically illustrated in FIG. 1 and designated by numeral 78. The build up 78 prevents water from traveling freely along the drain channel 74 and along the furrows 72. The instant apparatus 10 is designed to rectify this problem.

In operation, the furrow opener 10 is attached to the tractor 16 with the attachment assembly 14 and the cross member 52. The wheel 12 is allowed to freely rotate about the central shaft 20 and the side arms 50. As the wheel 12 rotates, the blades 60 move in turn across the bottoms of the furrows 72, forcing the accumulated obstructing material 78 to move to the sloping side 80 of the row 70. Since the distances between the furrows 72 may differ, the operator, prior to using the wheel 10, adjusts the length of the arms 24 such that the distance between adjacent arms 24 is approximately equal to the distance between the centers of the adjacent furrows 72.

In a sugarcane field, the typical distance between the furrows 72 is about 70 inches. The arms 24 may have an approximate length of about 59-60 inches, such that the blades 60 move across the bottoms of the furrows with the revolution of the wheel 12, forced to advance along the field by the tractor 16. The length of the arms 24 can be also adjusted to accommodate the need for greater or less depth to form a compressed, smooth sidewall 80 of the row 70. The cleaning action of the furrow-cleaning machine of the present invention includes the depth control of the furrows while retaining the size of the rows relatively compacted to prevent erosion by water.

The furrow cleaning apparatus 10 of the present invention is easily manufactured and maintained since it is made of lightweight tubular material that can be easily propelled along the field with conventional farm implements. The radial arms 24 keep the blades 60 in a substantially constant pivotal position relative to the ground, when the extension of the blades 60 from the center central disks 22 is properly adjusted by the user prior to attachment of the wheel 12 to the tractor 16.

The tractor wheels 82 moving across the field may leave a certain depression in the soil. However, the blades 60 following the tractor 16 will remedy this problem and open the furrows again. The apparatus 10 can be used following a ditch digger operation, or following heavy rain, or when needed. By moving the blades 60 in the furrows 72, the apparatus 10 of the present invention again clears the furrows, returning the field to the desired position of setting furrows of equal depth throughout the field. The weight of the wheel 12 is sufficient to press down the mud with the blade 60, with the angle of the blade 60 helping push the dirt to the side of the row.

Many changes and modifications may be made in the design of the present invention without departing from the spirit thereof. I, therefore, pray that my rights to the present invention be limited only by the scope of the appended claims.

1. A furrow cleaner apparatus for attachment to a towing unit having a pair of rotating wheels spaced at a pre-determined distance from each other, the apparatus comprising:
an attachment assembly for connection to the towing unit;
a rotatable wheel connected to said attachment assembly, said wheel comprising a plurality of furrow-opening elongated blades supported in a substantially parallel relationship to a central shaft of the wheel and transversely to a path of travel of the towing unit, said blades moving in dimensional symmetry with respect to the plane of rotation of the wheel so as to retain a constant alignment of the blades with a furrow, each of said blades having longitudinal dimensions greater than the distance between the spaced wheels of the towing unit; and
a means for connecting said central shaft to the attachment assembly.

2. The apparatus of claim 1, wherein each of said blades is securely attached to a plurality of arms extending radially in relationship to the central shaft.

3. The apparatus of claim 2, wherein each of said arms is longitudinally adjustable to allow extension of said blades to a pre-determined distance from the central shaft such that a distance between adjacent blades is approximately equal to a distance between centers of adjacent furrows.

4. The apparatus of claim 2, wherein each of said arms comprises a pair of telescoping portions allowing longitudinal extension of said arms to a pre-determined length to facilitate contact of adjacent blades with the soil in adjacent furrows.

5. The apparatus of claim 2, further comprising a plurality of parallel disks secured to the central shaft, and wherein one end of each of said arms is securely attached to a respective disk.

6. The apparatus of claim 1, wherein said means for connecting the central shaft comprises a pair of mirror opposed side arms attached to opposing ends of the central shaft and a cross member connecting said supporting arms and detachably engaged with the attachment assembly.

7. The apparatus of claim 6, wherein said side arms have longitudinal dimensions greater than said radially extending arms.

8. The apparatus of claim 6, further comprising a retainer carried by an end of said central shaft, and wherein each of said side arms is engaged with said retainer.

9. The apparatus of claim 1, wherein each of said blades comprises an elongate member having a generally V-shaped cross-section, with an apex of the elongate member being oriented outwardly in relation to the central shaft.

10. An apparatus for clearing eye of a furrow, the apparatus being adapted for attachment to a towing implement suitable for movement along the ground ahead of the furrow clearing apparatus, the towing implement having a pair of the rotating wheels spaced at a pre-determined distance from each other, the apparatus comprising:
a rotatable wheel with a central shaft, comprising a plurality of furrow-opening elongated blades supported in a substantially parallel relationship to the central shaft and transversely to a path of travel of the implement, said blades moving in dimensional symmetry with respect to the plane of rotation of the wheel so as to retain a constant alignment of the blades with the eye of the furrow, each of said blades having a longitudinal dimension greater than the distance between rotating wheels of the towing implement.

11. The apparatus of claim 10, wherein each of said blades comprises an elongate member having a generally V-shaped cross-section, with an apex of the elongate member being oriented outwardly in relation to the central shaft.

12. The apparatus of claim 10, wherein bottom edges of the blades are maintained at a substantially constant vertical position relative to the ground by a plurality of radial arms extending from the central shaft, said arms being adapted for variable longitudinal extension in relation to the central shaft, so as to retain the bottom edges of adjacent blades in contact with soil in adjacent furrows.

13. The apparatus of claim 12, wherein each of said arms comprises telescopically extendable portions to allow adjustment of the longitudinal extension of each of said arms in relation to the central shaft.

14. The apparatus of claim 12, wherein said shaft is rotatably mounted between a pair of side arms extending from opposite ends of the shaft in mirror opposed relationship to each other, said side arms carrying a connecting member between free ends thereof.

15. The apparatus of claim 14, wherein said side arms have longitudinal dimensions greater than said radially extending arms.

16. The apparatus of claim 14, wherein said connecting member is adapted for detachable mounting behind said implement.

17. The apparatus of claim 12, further comprising a plurality of parallel disks secured to the central shaft, and wherein one end of each of said arms is securely attached to a respective disk.

18. A method of clearing a plurality of adjacent furrows, comprising the following steps:
providing a towing implement;
providing a rotatable wheel with a central shaft, comprising a plurality of furrow-opening elongated blades supported in a substantially parallel relationship to the central shaft and transversely to a path of travel of the implement, each of said blades having a longitudinal dimension slightly smaller than a longitudinal dimension of said central shaft;
securing said wheel behind the towing implement;
imparting rotation on said wheel and causing at least one of the blades to move across bottom of the furrow, thereby moving obstructing material from the bottom of the furrow to a side of an adjacent row.

19. The method of claim 18, further comprising a step of maintaining contact edges of the blades at a substantially constant vertical position relative to the ground.

20. The method of claim 18, further comprising a step of selectively adjusting relative extension of the blades from the central shaft to thereby maintain contact edges of adjacent blades in relative contact with centers of adjacent furrows.
